(19) United States
(12) Patent Application Publication
(10) Pub. No.: US 2019/0111548 A1
(43) Pub. Date: Apr. 18, 2019

(54) SOCKET STRUCTURE

(71) Applicant: GUOCHANG COLD FORGING CO., LTD., Taichung City (TW)

(72) Inventor: TING-WEI CHU, Taichung City (TW)

(21) Appl. No.: 15/784,159

(22) Filed: Oct. 15, 2017

(51) Int. Cl. B25B 13/10

(52) U.S. Cl. CPC B25B 13/102

(57) ABSTRACT

A socket structure contains: a body, a fitting element, a first spring, a drive shaft, and a second spring. The body includes a first accommodation groove, a connection slot, a first trough, and a second trough. The fitting element includes a front section and a rear section, wherein the rear section of the fitting element has a notch, and the body includes at least one positioning element. The first spring is housed in the first trough and its first end abuts against the first trough and the second trough, and a second end of the first spring is biased against the rear section. The drive shaft includes a polygonal extension and a peripheral rib. A first end of the second spring abuts against the second trough, and a second end of the second spring pushes the polygonal extension to extend out of the second accommodation groove.

### FIELD OF THE INVENTION

The present invention relates to a socket structure which matches with sockets of various shapes.

### BACKGROUND OF THE INVENTION

A conventional saw is applied to saw objects, such as woods, plastic pipes, or metal objects etc. While sawing the objects, a handle of the saw is pulled and pushed repeatedly by a user so as to press a saw blade to saw the objects. However, it is exhausted to pull and push the handle repeatedly.

A socket or a socket tool is employed to fix or remove a screw bolt with or from a nut. The socket is applied to screw or unscrew a quadrilateral, hexagonal or octagonal nut, however, the socket cannot match with gear, ratchet, and start shaped of screws or nuts.

The present invention has arisen to mitigate and/or obviate the afore-described disadvantages.

### SUMMARY OF THE INVENTION

The primary aspect of the present invention is to provide a socket structure which matches with sockets of various shapes.

To obtain the above mentioned aspect, a socket structure provided by the present invention contains: a body, a fitting element, a first spring, a drive shaft, and a second spring.

The body includes a first accommodation groove which is polygonal and is formed on a first end of the body so as to fit with a workpiece, and the body includes a connection slot arranged on a second end of the body and configured to connect with a wrench tool, a first trough communicating with the first accommodation groove, and a second trough communicating with the first trough. A diameter of the first trough is more than the second trough, a fitting element is movably accommodated in the first accommodation groove and the first trough, and the fitting element includes a front section, a diameter of which corresponds to the first accommodation groove, the fitting element also includes a rear section fitting with the first trough, and a length of the front section is less than a depth of the first accommodation groove; a diameter of the front section of the fitting element is less than a second accommodation groove of the fitting element in the first accommodation groove, and the rear section of the fitting element is polygonal and communicates with an opening of the fitting element opposite to the second accommodation groove; the rear section of the fitting element has a notch formed on an outer wall thereof, and the body includes at least one positioning element fitting between the first trough and the notch so as to limit a sliding distance of the fitting element.

The first spring is housed in the first trough, wherein a first end of the first spring abuts against the first trough and the second trough, and a second end of the first spring is biased against the rear section of the fitting element so that the front section aligns with the first accommodation groove.

The drive shaft includes a polygonal extension accommodated in the opening, a peripheral rib formed on an outer wall of the drive shaft and contacting with the rear section so as to limit a maximum moving distance of the drive shaft.

A first end of the second spring abutting against a bottom of the second trough, and a second end of the second spring pushing the polygonal extension to extend out of the second accommodation groove of the fitting element.

Preferably, the body further includes a third accommodation groove defined in the first trough of the body so as to house the positioning element, and the positioning element is a C retainer; the rear section of the fitting element has a tilted face formed on an edge of the rear section.

Preferably, the first end of the second spring abuts against the peripheral rib of the drive shaft, and a peg extends outward from a top of the peripheral rib so as to fit with the second spring.

Preferably, the first accommodation groove is pentagonal, and the second accommodation groove and the polygonal extension are hexagonal.

### BRIEF DESCRIPTION OF THE DRAWINGS

FIG. 1 is a perspective view showing the assembly of a socket structure according to a preferred embodiment of the present invention.

FIG. 2 is a cross-sectional perspective view showing the exploded components of the socket structure according to the preferred embodiment of the present invention.

FIG. 3 is a cross sectional plan view showing the assembly of the socket structure according to the preferred embodiment of the present invention.

FIG. 4 is a cross sectional plan view showing the operation of the socket structure according to the preferred embodiment of the present invention.

FIG. 5 is another cross sectional plan view showing the operation of the socket structure according to the preferred embodiment of the present invention.

### DETAILED DESCRIPTION OF THE PREFERRED EMBODIMENTS

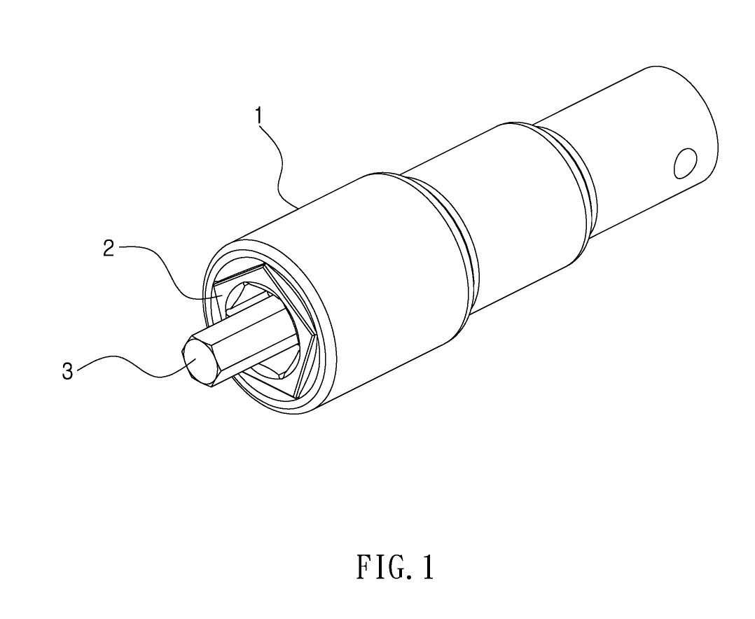

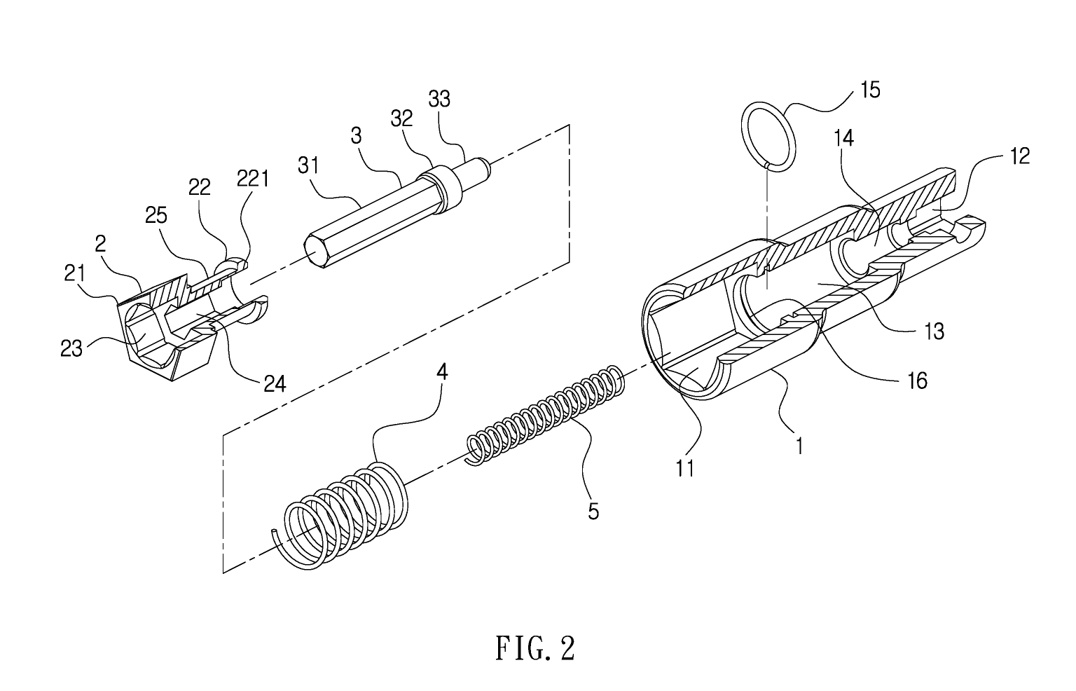

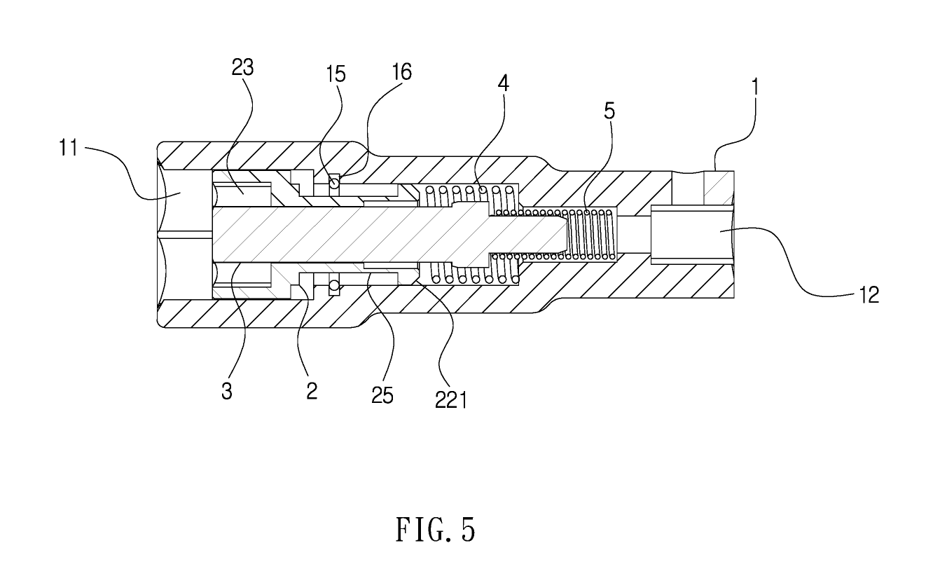

With reference to FIGS. 1-5, a socket structure according to a preferred embodiment of the present invention comprises: a body 1, a fitting element 2, a drive shaft 3, a first spring 4, and a second spring 5.

The body 1 includes a first accommodation groove 11 which is polygonal and is formed on a first end of the body 1 so as to fit with a workpiece, and the body 1 includes a connection slot 12 arranged on a second end thereof and configured to connect with a wrench tool, a first trough 13 communicating with the first accommodation groove 11, and a second trough 14 communicating with the first trough 13, wherein a diameter of the first trough 12 is more than the second trough 14. The fitting element 2 is movably accommodated in the first accommodation groove 11 and the first trough 13, and the fitting element 2 includes a front section 21, a diameter of which corresponds to the first accommodation groove 11. The fitting element 2 also includes a rear section 22 fitting with the first trough 13, and a length of the front section 21 is less than a depth of the first accommodation groove 11 so that when the fitting element 2 slidably retracts in the body 1, the front section 21 removes from the first accommodation groove 11.

A diameter of the front section 21 of the fitting element 2 is less than a second accommodation groove 23 of the fitting element 2 in the first accommodation groove 11, and the rear section 22 of the fitting element 2 is polygonal and communicates with an opening 24 of the fitting element 2 opposite to the second accommodation groove 23. The rear section 22 of the fitting element 2 has a notch 25 formed on an outer wall thereof, and the body 1 includes at least one positioning element 15 fitting between the first trough 13 and the notch 25 so as to limit a sliding distance of the fitting element 2.

The first spring 4 is housed in the first trough 13, wherein a first end of the first spring 4 abuts against the first trough 13 and the second trough 14, and a second end of the first spring 4 is biased against the rear section 22 of the fitting element 2 so that the front section 21 aligns with the first accommodation groove 11.

The drive shaft 3 includes a polygonal extension 31 accommodated in the opening 24, a peripheral rib 32 formed on an outer wall of the drive shaft 3 and contacting with the rear section 22 so as to limit a maximum moving distance of the drive shaft 3.

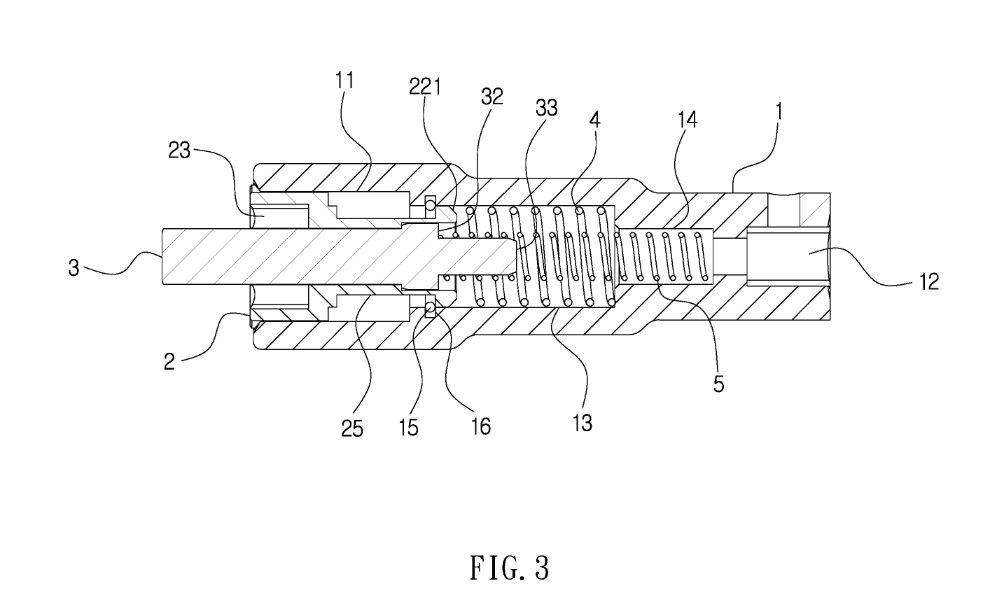

A first end of the second spring 5 abuts against a bottom of the second trough 14, and a second end of the second spring 5 pushes the polygonal extension 31 to extend out of the second accommodation groove 23 of the fitting element 2, hence when the drive shaft 3 and the fitting element 2 are not pressed, the fitting element 2 is located on the first accommodation groove 11, and the polygonal extension 31 extends out of the second accommodation groove 23 so as to match with a wrench tool (as shown in FIG. 3).

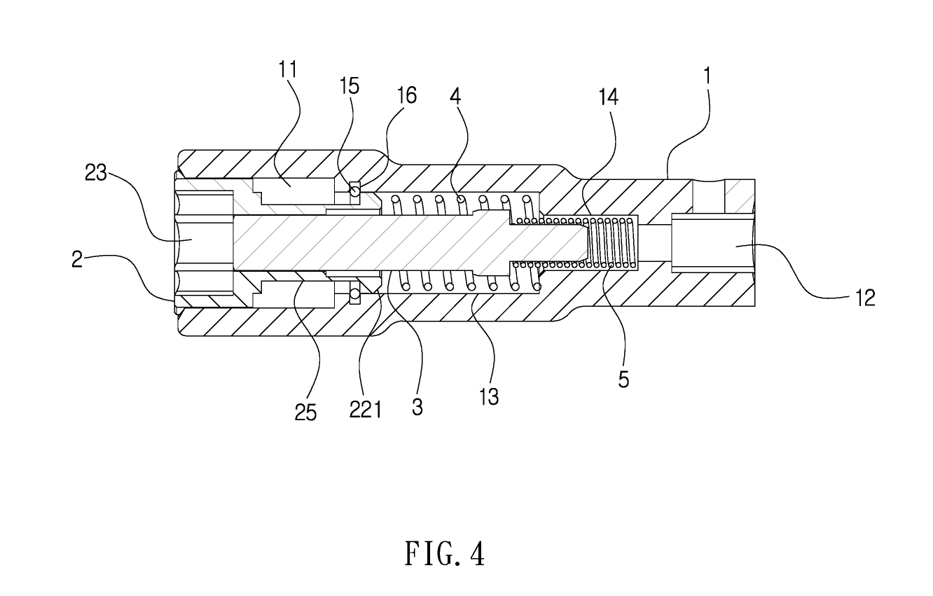

When the polygonal extension 31 corresponds to a first workpiece in the second accommodation groove 23, the drive shaft 3 forces the second spring 5 to retract into the body so as to release the second accommodation groove 23, thus driving the first workpiece, as illustrated in FIG. 4.

When the polygonal extension 31 corresponds to a second workpiece in the first accommodation groove 11, the fitting element 2 presses the first spring 4 and the drive shaft 3 forces the second spring 5 so that the first spring 4 and the second spring 5 retract into the body 1, thus releasing the second workpiece from the first accommodation groove 11.

The body 1 further includes a third accommodation groove 16 defined in the first trough 13 of the body 1 so as to house the positioning element 15, and the positioning element 15 is a C retainer. The rear section 22 of the fitting element 2 has a tilted face 221 formed on an edge of the rear section 22, such that the C retainer forces in the third accommodation groove 16, and the tilted face 221 ensures the rear section 22 of the fitting element 2 inserting through the C-retainer.

The first end of the second spring 5 abuts against the peripheral rib 32 of the drive shaft 3, and a peg 33 extends outward from a top of the peripheral rib 32 so as to fit with the second spring 5, hence the peg 33 avoids interfering the first spring 4 as pushing the second spring 5.

The first accommodation groove 1 is pentagonal, and the second accommodation groove 23 and the polygonal extension 31 are hexagonal. Thereby, the socket structure of the present invention matches with sockets of various shapes.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A socket structure comprising:
a body including a first accommodation groove which is polygonal and is formed on a first end of the body so as to fit with a workpiece, and the body including a connection slot arranged on a second end of the body and configured to connect with a wrench tool, a first trough communicating with the first accommodation groove, and a second trough communicating with the first trough, wherein a diameter of the first trough is more than the second trough, a fitting element is movably accommodated in the first accommodation groove and the first trough, and the fitting element includes a front section, a diameter of which corresponds to the first accommodation groove, the fitting element also includes a rear section fitting with the first trough, and a length of the front section is less than a depth of the first accommodation groove; a diameter of the front section of the fitting element is less than a second accommodation groove of the fitting element in the first accommodation groove, and the rear section of the fitting element is polygonal and communicates with an opening of the fitting element opposite to the second accommodation groove; the rear section of the fitting element has a notch formed on an outer wall thereof, and the body includes at least one positioning element fitting between the first trough and the notch so as to limit a sliding distance of the fitting element;
a first spring housed in the first trough, wherein a first end of the first spring abuts against the first trough and the second trough, and a second end of the first spring is biased against the rear section of the fitting element so that the front section aligns with the first accommodation groove;
a drive shaft including a polygonal extension accommodated in the opening, a peripheral rib formed on an outer wall of the drive shaft and contacting with the rear section so as to limit a maximum moving distance of the drive shaft; and
a first end of a second spring abutting against a bottom of the second trough, and a second end of the second spring pushing the polygonal extension to extend out of the second accommodation groove of the fitting element.

2. The socket structure as claimed in claim 1, wherein the body further includes a third accommodation groove defined in the first trough of the body so as to house the positioning element, and the positioning element is a C retainer; the rear section of the fitting element has a tilted face formed on an edge of the rear section.

3. The socket structure as claimed in claim 1, wherein the first end of the second spring abuts against the peripheral rib of the drive shaft, and a peg extends outward from a top of the peripheral rib so as to fit with the second spring.

4. The socket structure as claimed in claim 1, wherein the first accommodation groove is pentagonal, and the second accommodation groove and the polygonal extension are hexagonal.
